(19) United States
(12) Patent Application Publication
(10) Pub. No.: US 2025/0287909 A1
(43) Pub. Date: Sep. 18, 2025

(54) REMOTE CONTROLLED DOG CRATE

(71) Applicant: Guardian K9 Lock Solutions, LLC., Tarpon Springs, FL (US)

(72) Inventors: Harry B. Lee, JR., Tarpon Springs, FL (US); Timothy Baird, Piedmont, AL (US)

(73) Assignee: Guardian K9 Lock Solutions, LLC., Tarpon Springs, FL (US)

(21) Appl. No.: 19/226,869

(22) Filed: Jun. 3, 2025

Related U.S. Application Data
(63) Continuation-in-part of application No. 18/812,246, filed on Aug. 22, 2024.
(60) Provisional application No. 63/533,963, filed on Aug. 22, 2023.

(51) Int. Cl. A01K 1/02; E05B 9/02; E05B 47/00

(52) U.S. Cl. CPC A01K 1/0245; E05B 9/02; E05B 47/0004; E05B 2047/0016; E05B 2047/0058; E05B 2047/0073; E05B 2047/0084

(57) ABSTRACT

A dog crate system including a crate and a remote control. The crate is configured to contain a large dog, such as a security or law enforcement dog. The crate can be wirelessly opened using the remote control or another device. The crate includes a door and a body. The door includes a latch, a solenoid, and a receiver. The receiver can receive wireless control signals to actuate the solenoid and disengage the latch to open the door. The door can define an enclosed cavity to store the solenoid, receiver, and a battery. The body can define a floor having multiple protruding feet and a roof having multiple platforms. Multiple crates can stack by resting the feet of one crate on the platforms of another crate. The roof can define multiple shoulders adjacent to the platforms that secure the feet on a stacked crate in place.

### CROSS-REFERENCE TO RELATED APPLICATIONS

This application is a continuation-in-part of U.S. patent application Ser. No. 18/812,246 filed Aug. 22, 2024, which claims the benefit of U.S. Provisional Application No. 63/533,963 filed Aug. 22, 2023, which are both hereby incorporated by reference.

### BACKGROUND

The present disclosure relates to remote controlled animal crates.

Crates, kennels, and other containers are commonly used to hold animals, such as dogs, for a variety of purposes. For example, crates can be used to restrain an animal while transporting the animal, while handlers are busy or unavailable, as a part of training, and/or in other circumstances. Many crates require a user to manually open the crate to let the animal out. For example, the user normally must be present near the crate and must manually unlatch a door to release the animal. But situations can develop where a user may suddenly decide that the animal should be released but the user may be remote from the crate. For instance, the user may need to quickly release the animal in response to a cue and/or may be located away from the crate when needing to release the animal.

Examples where remote opening of a crate would be useful include trained police dogs used by police. The dog can be safely contained in a crate in a vehicle and if the handler encounters a situation where the dog would suddenly be useful, the handler could remotely open the crate to release the dog to assist the handler. In another example, a crate with remote opening could be located at a home or property protected by the dog. The home or property could be remotely monitored using video cameras and the create could be remotely opened if an intruder is identified.

There is a need for a remote operated animal crate. This can be accomplished through a combination of several design features described below.

### BRIEF DESCRIPTION OF THE DRAWINGS

FIG. 1 is a perspective view of a system including a crate and a remote control.

FIG. 2 is front perspective view of the FIG. 1 crate.

FIG. 3 is a rear perspective view of the FIG. 1 crate.

FIG. 4 is an exploded front perspective view of a door, a component of the FIG. 1 crate, with a cover partially removed.

FIG. 5 is a rear perspective view of the FIG. 4 door with a guard attached.

FIG. 6 is a perspective view of a kit including a latch assembly, a solenoid, a receiver, and a battery from the FIG. 1 system.

FIG. 7 is a front perspective view of the FIG. 4 door including the FIG. 6 latch assembly, solenoid, receiver, and battery.

FIG. 8 is a rear perspective view of the FIG. 7 door with the FIG. 5 guard removed.

FIG. 9 is an isolated perspective view of the FIG. 1 crate with the FIG. 4 door in an open position.

FIG. 10 is a perspective view of the FIG. 1 remote control.

FIG. 11 is a front perspective view of the FIG. 4 door.

FIG. 12 is a rear perspective view of the FIG. 4 door.

FIG. 13 is a rear perspective view of a cover, a component of the FIG. 4 door.

FIG. 14 is rear elevation view of a guard, a component of the FIG. 4 door.

FIG. 15 is a side elevation view of the FIG. 14 guard.

FIG. 16 is a rear perspective view of a first strut, a component of the FIG. 1 crate.

FIG. 17 is a front perspective view of the FIG. 16 first strut.

FIG. 18 is a rear perspective view of a second strut, a component of the FIG. 1 crate.

FIG. 19 is a front perspective view of the FIG. 18 second strut.

FIG. 20 is a cross-sectional perspective view of the FIG. 1 crate taken along line 20-20 in FIG. 3.

FIG. 21 is a perspective view of a second crate stacked on top of the FIG. 1 crate.

FIG. 22 is a bottom perspective view of the FIG. 1 crate.

FIG. 23 is a top perspective view of the FIG. 1 crate.

FIG. 24 is an isolated perspective view of the FIG. 21 crates showing a front platform and a front foot.

FIG. 25 is an isolated perspective view of the FIG. 21 crates showing a middle platform and a middle foot.

FIG. 26 is an isolated perspective view of the FIG. 21 crates showing a rear platform and a rear foot.

### DESCRIPTION OF THE SELECTED EMBODIMENTS

For the purpose of promoting an understanding of the principles of the claimed invention, reference will now be made to the embodiments illustrated in the drawings and specific language will be used to describe the same. It will nevertheless be understood that no limitation of the scope of the claimed invention is thereby intended. Any alterations and further modifications in the described embodiments, and any further applications of the principles of the claimed invention as described herein are contemplated as would normally occur to one skilled in the art to which the claimed invention relates. One embodiment of the claimed invention is shown in great detail, although it will be apparent to those skilled in the relevant art that some features that are not relevant to the present claimed invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “left”, “right”, “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

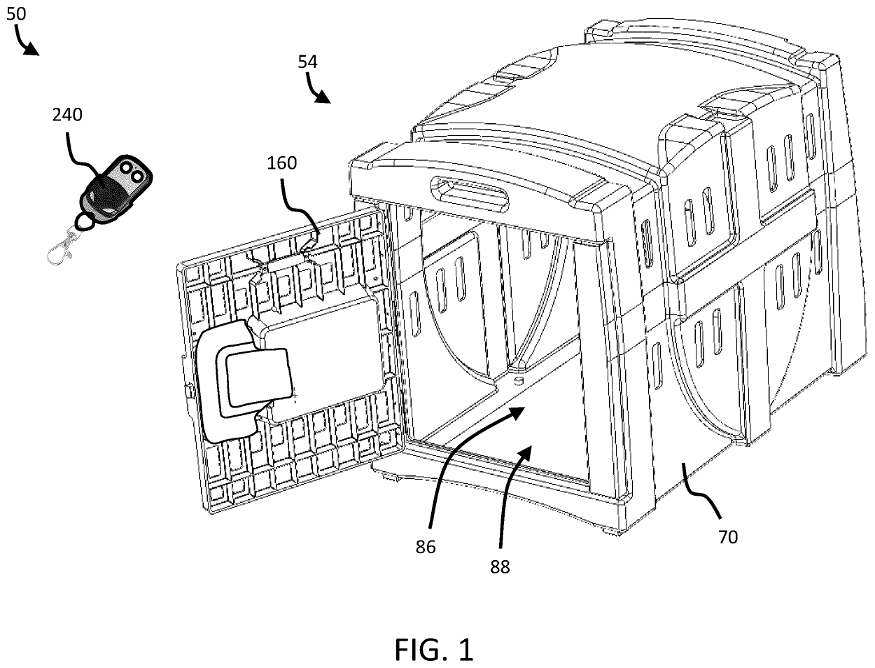

Referring to FIG. 1, a system 50 is configured to hold and release an animal such as a dog. System 50 typically includes a crate 54. Crate 54 is configured to selectively contain and restrain an animal. Typically crate 54 is used to hold larger animals, such as trained guard dogs, law enforcement dogs, and/or other animals. For example, crate can hold dogs that weigh 50 pounds, 70 pounds, 90 pounds, or more. Crate 54 is generally strong enough to withstand strong impacts and to reliably secure such animals. Further, crate 54 is wirelessly controllable. System 50 allows a user to remotely open the door to release the animal from crate 54. In the illustrated example, system 50 can include a remote control 240 that allows a user to open crate 54. In some examples, system 50 can interface with external devices to control crate 54 wirelessly. Releasing the animal remotely can allow the user to react quickly when needed. For example, for security and/or law enforcement purposes, a user may need to quickly release a trained dog from crate 54 in response to a threat. Using traditional crates can waste time by requiring the user to physically move to the crate and manually release the animal. Further, remotely releasing the animal can allow the user to release the animal during unexpected situations. In some cases, the animal may be dangerous and pose a risk if uncontained without guidance. Traditional crates typically require the user to manually open the crate to release the animal, which can limit the availability of the animal in suddenly developing situations. Using system 50, the user can release the animal from a remote location on demand, while having the animal otherwise safely contained in the crate when they are not needed.

Crate 54 generally includes a body 70 and a door assembly that includes door 160. Crate 54 has a top side 74, a bottom side 76, a front side 78, a back side 80, a first lateral side 82, and a second lateral side 84. Body 70 forms the main structure of crate 54. Body 70 can define multiple apertures to provide airflow and/or visibility into crate 54. Body 70 can be made of a strong and rigid material, such as a hard plastic. In one example, body 70 can be formed using rotational molding. In other words, body 70 can be formed by rotating and heating a mold such that the plastic material settles with a uniform thickness. In other examples, body 70 can be formed using injection molding and/or other processes. Forming body 70 in this way forms body 70 as a single monolithic part. Forming body 70 as a single monolithic part can ensure that body 70 is strong and durable. As shown, body 70 defines an interior space 86 that is configured to hold an animal. Body 70 defines an opening 88 on front side 78 that provides space for an animal to enter interior space 86. In one example, interior space 86 can be large enough to hold a large dog, such as a dog weighing more than 50 pounds, more than 70 pounds, or more than 90 pounds as examples. Similarly, opening 88 can be large enough to allow such a dog and/or another type of animal to pass through opening 88.

Door 160 is rotatably coupled to body 70 on front side 78. Door 160 can be made of the same material as body 70, such as a rigid plastic material. As some examples, door 160 can be made through injection molding, blow molding, and/or rotational molding. When door 160 is closed, door 160 covers opening 88 and encloses interior space 86. Similar to body 70, door can define multiple apertures to provide airflow and visibility into crate 54. Remote control 240 allows a user to unlatch door 160 such that door 160 is free to rotate out from opening 88. Door 160 can be biased toward the open position such that door 160 swings open when unlatched remotely. Further, door 160 can contain various electronic components of crate 54. Housing the components in door 160 can support a compact design. Further, housing the components in this way can protect the components from environmental factors, such as moisture or dirt, and from being damaged by the animal.

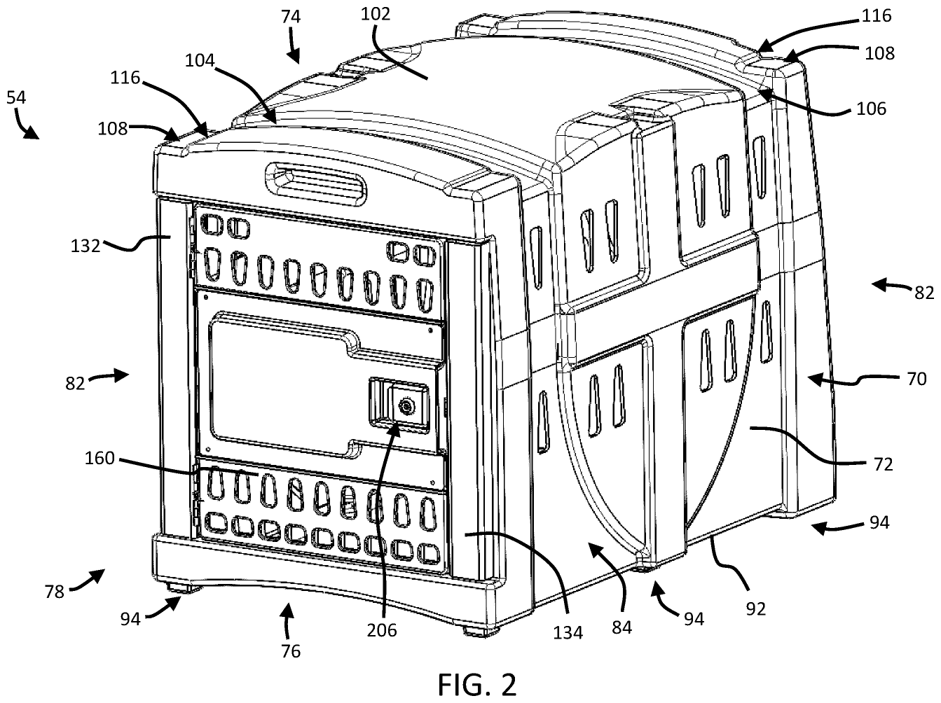

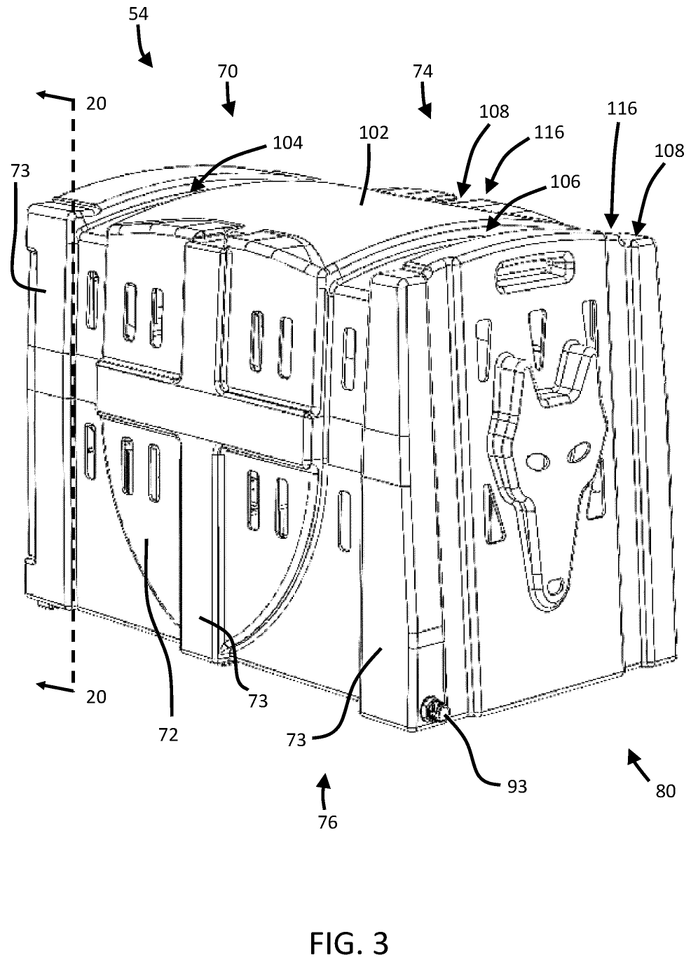

Referring to FIGS. 2 and 3, body 70 includes a floor 92 on bottom side 76, a roof 102 on top side 74, and sidewalls 72 that extend between floor 92 and roof 102 on lateral sides 82 and 84. Sidewalls 72 generally enclose interior space 88 on laterals sides 82 and 84. Further, sidewalls 72 help provide structural support between floor 92 and roof 102. Sidewalls 72 can include one or more supports 73 that provide additional structural strength against vertical loads. In the illustrated example, supports 73 can be in the form of molded ribs that extend vertically along lateral sides 82 and 84. For instance, body 70 can include additional bends that form supports 73. Such bends provide additional material at certain locations so as to resist or fully prevent buckling and/or other deformation. Forming supports 73 in this way allows supports 73 to stiffen body 70 against a vertical load without increasing the thickness of sidewalls 72. Using integrated supports 73 in this form therefore allows body 70 to be highly strong while maintaining a consistent wall thickness and/or maintaining a relatively low weight of body 70. In another example, sidewalls 72 can form supports 73 through areas of increased wall thickness and/or other added material, such as internal brackets and/or struts. In yet another example, sidewalls 72 can receive reinforcing inserts that strengthen body 70. For instance, supports 73 can include reinforcing inserts that are attached within and/or around the molded ribs on sidewalls 72.

Floor 92 is generally configured to provide support for the animal within crate 54. Floor 92 can extend fully across bottom side 76 of body 70 and can be impermeable to water. For example, floor 92 can form a continuous barrier separating interior space 86 from the outside on bottom side 76. Unlike wire frame crates or other types of crate constructions, using a solid water-impermeable floor 92 can prevent leakage from crate 54 and can help insulate interior space 86 from the outside environment. This allows floor 92 to contain messes and facilitates cleaning the interior of crate 54. Body 70 can further include a drain 93 that allows a user to empty liquid from interior space 86 of crate 54. For example, drain 93 can allow a user to easily dump out messes created in interior space 86 and/or to clear out water and/or cleaning solutions after cleaning interior space 86 of crate 54. Drain 93 can also be connected to a piping system (not illustrated) to continuously drain interior space 86.

Body 70 further includes multiple feet 94 that extend from floor 92 on bottom side 76. Feet 94 are configured to support the body 70 relative to a ground surface. Feet 94 generally elevate the floor 92 above the ground surface. Raising floor 92 from the ground can provide additional protection within interior space 86 from the environment, such as from moisture, dirt, mud, and/or cold ground temperatures as examples. Feet 94 can be integrally formed with the rest of body 70. Alternatively, feet 94 can be attached to body 70 as separate parts.

Roof 102 is generally configured to enclose interior space 86 on top side 74 and to protect the animal from environmental factors, such as rain, direct sunlight, and/or other weather conditions. Roof 102 can be arched and/or dome-shaped to divert rain and/or falling objects off of roof 102. Compared to other flatter roofs, roof 102 can provide better water runoff to prevent rain and other water from pooling on roof 102. Roof 102 is generally strong and sturdy. For example, the robust design and monolithic construction of body 70 can strengthen roof 102. The arched shape can contribute to the strength of roof 102. For example, the arched shape can distribute a load more evenly compared to a flat roof. Roof 102 can be much stronger than flatter roofs due to the arched shape. The strong and sturdy construction can allow roof 102 to support another crate stacked on top of crate 54. In the illustrated example, portions of floor 92 can be curved to mirror the shape of roof 102 such that floor 92 conforms to roof 102 when multiple crates are stacked. The conforming shapes of crates 54 can help fix crates 54 in place relative to one another and support stable stacking. In addition, curving floor 92 can help drain fluids such as urine away from the middle portion of floor 92 toward the edges where drain 93 is located.

To further support stacking, body 70 defines multiple platforms 108 and multiple shoulders 116 on roof 102. Platforms 108 are generally positioned to mirror the location of feet 94. In other words, the positions of platforms 108 and the positions of feet 94 can overlap when crate 54 is viewed from directly above. Platforms 108 are configured to support feet 94 on another crate stacked on top side 74. Platforms 108 support a secure stacking arrangement by providing a stable surface for feet 94 to rest. In the illustrated example, roof 102 defines six platforms 108 positioned around a perimeter of roof 102. Platforms 108 can be evenly spaced between front side 78 and back side 80 to distribute the weight of the other crate. Supports 73 can be positioned between platforms 108 and feet 94. Supports 73 act as columns between feet 94 and platforms 108 to provide additional compressive strength against vertical loads at those locations. Arranging supports 73 in this way can provide additional structural support for platforms 108 to support the other crate.

Shoulders 116 are generally configured to bolster feet 94 on a stacked crate and to prevent the stacked crate from shifting on top of crate 54. For example, shoulders 116 can fix the position of the stacked crate between front side 78 and back side 80 and between first and second lateral sides 82 and 84. Shoulders 116 generally extend above platforms 108 on top side 74. In the illustrated example, shoulders 116 can be integrally formed with roof 102 and body 70. Shoulders 116 can be positioned around platforms 108 in various arrangements. As shown, shoulders 116 are positioned adjacent platforms 108. Shoulders 116 positioned near different platforms 108 can cooperate to collectively secure feet 94 on another crate in place.

Roof 102 can further define a front groove 104 and a rear groove 106. Grooves 104 and 106 are configured to receive a tie-down, such as a strap, rope, chain, and/or other type of tie-down. Using tie-downs can secure crate against a ground surface, such as an indoor floor, an outdoor surface, and/or the floor in a vehicle as examples. For instance, grooves 104 and 106 allow tie-downs to secure crate 54 in place against the bed of a truck and/or other vehicle during transport. Body 70 can define any number of grooves positioned in a variety of ways. In the illustrated example, front groove 104 is positioned near front side 78 and rear groove 106 is positioned near back side 80. Such an arrangement allows crate to be secured at multiple points with a relatively even distribution of securing force from the tie-downs. In another example, roof 102 can define one central groove to allow a tie down to secure crate from the center. In yet another example, roof 102 can define more than two grooves positioned at various points between front side 78 and back side 80 along roof 102.

In the illustrated example, body 70 further includes one or more handles 128. Handles 128 can be formed as indents defined by body 70. Body 70 can define one handle 128 on front side 78 and one handle 128 on back side 80. Handles 128 can facilitate lifting crate 54, such as when placing or removing crate 54 from a vehicle. Further, handles 128 can help a user lift and stack multiple crates 54.

In one version, crate 54 can include struts 132 and 134 attached to body 70 near opening 88. Struts 132 and 134 can strengthen crate 54. Particularly, struts 132 and 134 provide structural support to body 70 around opening 88 which can otherwise be a weak point for crate 54. Struts 132 and 134 can be made of a stronger and/or more rigid material than the material of body 70. For example, struts 132 and 134 can be made of steel and/or another metal. As shown, struts 132 and 134 can be positioned along lateral sides 82 and 84 of crate 54. Strut 132 can be positioned on first lateral side 82 along opening 88. Strut 134 can be positioned on second lateral side 84 along opening 88. Door 160 can be mounted to strut 132 using a hinge strut 134 can receive latch 208 (described below) when closed. In this way, struts 132 and 134 can reinforce coupling door 160 to crate 54. Using struts 132 and 134 to reinforce door 160 can assist crate 54 to securely hold the animal in interior space 86 without risk of the animal damaging or breaking through door 160.

Crate further includes a latch assembly 206 mounted on door 160. Latch assembly 206 is configured to selectively secure door 160 in a closed position within opening 88. Latch assembly 206 can be operated wirelessly via remote control to open door 160. In one example, latch assembly 206 can be biased in an engaged state such that door 160 is normally held in place within opening 88. Latch assembly 206 further can allow a user manually disengage and open door 160.

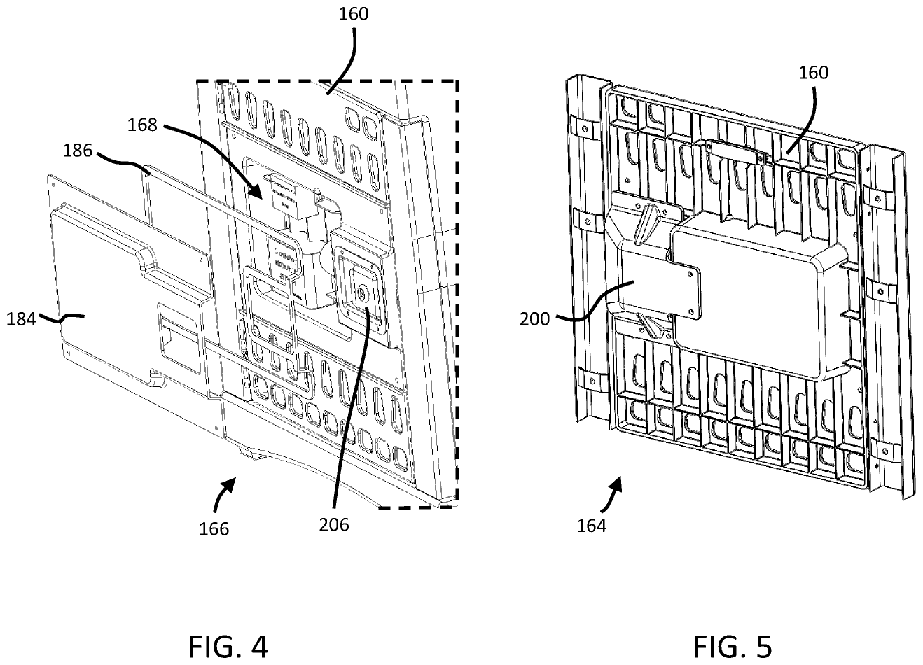

Referring to FIGS. 4-6, door 160 defines an enclosed cavity 168. Enclosed cavity 168 provides space to store various electrical and/or mechanical components of crate 54. Storing such components within door 160 can protect the components from the animal and/or various environmental factors. As shown, crate 54 can include a cover 184 that is removably attached to door 160. Cover 184 generally bounds a portion of enclosed cavity 168. When cover 184 is attached to door 160, cover 184 and door 160 can fully enclose cavity. By removing cover 184, a user can access the internal components within enclosed cavity 168, such as to make repairs, upgrades, and/or replace parts. Cover 184 can then be reattached to enclose and protect the internal components. In the illustrated example, cover 184 can be attached on exterior side 166 of door 160. This allows a user to access enclosed cavity 168 while the animal is secured within crate 54. Cover 184 can be attached to door 160 through one or more fasteners, such as screws and/or bolts. Alternatively or additionally, cover 184 can attach to door 160 through a friction fit, a snap-fit connection, and/or other ways. Further, cover 184 is configured to seal against door 160. In one example, cover 184 can directly seal against door 160 to block water from entering enclosed cavity 168. In another example, crate 54 can include a seal 186 positioned between cover 184 and door 160. Seal 186 can be made of a flexible rubber and/or foam material that forms a waterproof boundary between door 160 and cover 184. Using a waterproof boundary can ensure that the internal electronic components are protected from moisture and/or other potential harms.

As shown in FIG. 5, crate can further include a guard 200. Guard 200 can be attached on interior side 164 of door 160. Guard 200 can protect and enclose additional components that are outside enclosed cavity 168. For example, guard 200 can protect parts of latch assembly 206. By attaching guard 200 on interior side 164 of door 160, guard 200 protects components from being damaged, tampered, and/or otherwise affected by the animal when held in crate 54. Protecting components, such as latch assembly 206, in this way can ensure that door 160 remains latched and closed when desired despite any aggressive behavior by the animal.

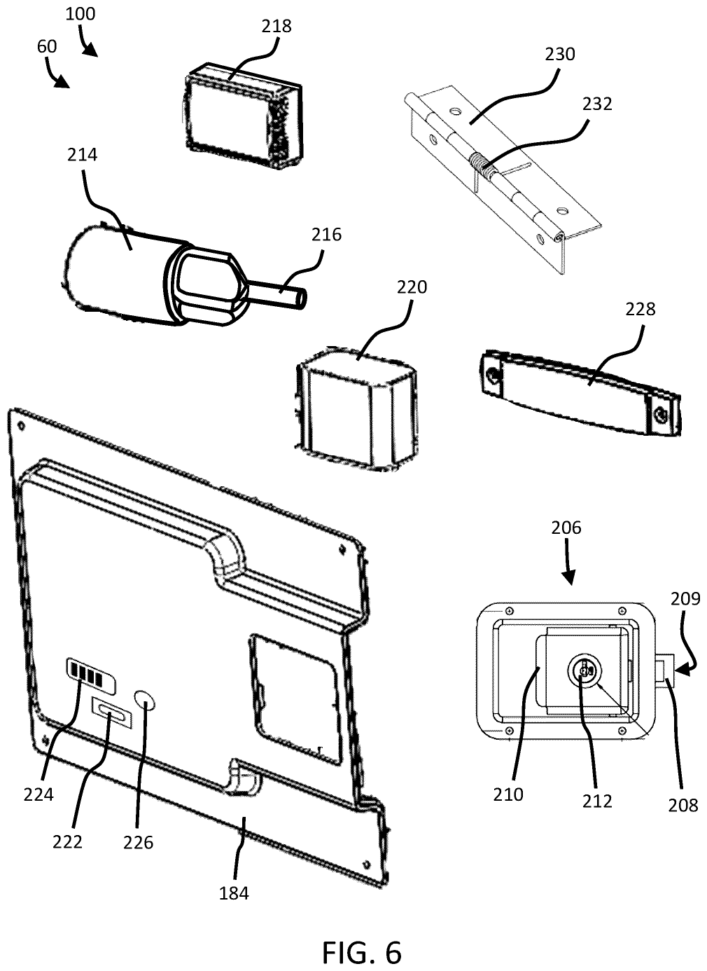

Referring to FIGS. 6-9, system 50 typically includes a solenoid 214 and a receiver 218. Solenoid 214 is generally an electromechanical actuator that is coupled to latch assembly 206. Solenoid 214 is configured to disengage latch assembly 206 to open door 160. Receiver 218 is electrically connected to solenoid 214. Receiver 218 can receive control signals from remote control 240 and/or another source. Upon receiving a control signal, receiver 218 can actuate solenoid 214 to release door 160. System 50 can further include a battery 220, a light 228, a hinge 230, and/or a spring 232.

As illustrated, latch assembly 206 generally includes a latch 208 and a handle 210. Latch 208 is movable between an engaged state and a disengaged state. Latch 208 can hold door 160 closed when in the engaged state. When latch 208 moves to the disengaged state, door 160 is free to rotate open. In one example, latch 208 can be biased toward the engaged state such that door 160 is held closed after a user closes door 160. Latch 208 can define a tapered surface 209. Tapered surface 209 guides latch 208 to automatically reset (i.e. move from engaged to disengaged) when door 160 closes. Using latch 208 with tapered surface 209 therefore can allow door 160 to be self-closing. Handle 210 is operatively connected to latch 208. When a user turns and/or pulls on handle 210, handle 210 can move latch 208 between engaged and disengaged states. Handle 210 is positioned on exterior side 166 of door 160 so as to be accessible to users outside crate 54. Handle 210 allows a user to manually move latch 208 to the disengaged state to open door 160 without having to energize solenoid 214. Using handle 210 may be more convenient for the user in some circumstances. Further, handle 210 can allow a user to open crate 54 when power is unavailable.

Latch assembly 206 can further include a lock 212. Lock 212 can provide a mechanical override for latch assembly 206. Lock 212 is configured to secure latch assembly 206 in an engaged state regardless of the state of solenoid 214 and/or handle 210. Lock 212 can receive a key. When a user turns lock 212 using the key, lock 212 can secure latch 208 in the engaged state. Alternatively, lock 212 can engage a separate bolt to secure door 160 closed. Using lock 212 can ensure that door 160 remains closed despite incidental or unauthorized attempts to open crate 54 using handle 210, remote control 240, and/or other devices.

In the illustrated example, latch assembly 206 can integrate latch 208, handle 210, and/or lock 212 together as a single component. For instance, latch assembly 206 can include a common housing that encloses and secures latch 208, handle 210, and lock 212. In one example, latch assembly 206 can be a commercially available part. Using an integrated and/or commercially available latch assembly 206 can allow users to easily make replacements and/or repairs to door 160. Further, latch assembly 206 can incorporate latch 208, handle 210, and lock 212 in a compact and strong construction. Integrating such components into latch assembly 206 in this way can strengthen each individual component. For example, latch 208 can be reinforced to withstand greater forces as a part of latch assembly 206. Reinforcing latch 208 in this way can ensure that door 160 remains closed under high stress, such as if the animal tries to force door 160 open.

Solenoid 214 generally includes a piston 216. Piston 216 moves when solenoid transitions between energized and deenergized states. In one example, solenoid 214 can include a conductive coil and piston 216 can be made of a ferrous material, such as steel or iron. In that example, piston 216 can extend into the coil and energizing coil can cause piston 216 to move. In other examples, solenoid 214 can include a hydraulic, pneumatic, and/or a different form of electromechanical actuator to move piston 216.

Solenoid 214 can include a push pull type solenoid that is biased to one state when deenergized. In one example, solenoid 214 can be biased toward an extended position and can retract when energized. In other words, piston 216 can slide inward toward solenoid 214 when solenoid 214 is energized. Alternatively, solenoid 214 can be biased to be retracted when deenergized and can extend when energized. Solenoid 214 is generally configured to momentarily actuate in response to a control signal. For example, solenoid 214 can be momentarily energized to retract and disengage latch 208 just long enough to open door 160. Using solenoid 214 in this arrangement allows solenoid 214 to keep latch 208 engaged without requiring solenoid 214 to constantly draw power. Solenoid 214 therefore provides a failsafe to keep crate 54 closed in case battery 220 runs out of power and/or power to solenoid 214 is otherwise lost. Further, compared to constantly powering solenoid 214, this arrangement greatly reduces power consumption. Alternatively or additionally, solenoid 214 can include a bistable, bidirectional, and/or other type of solenoid.

Generally, solenoid 214 is more powerful than actuators used in other electronic latches. Solenoid 214 is configured to produce a high force, such as at least 60 Newtons, 80 Newtons, 100 Newtons, 120 Newtons, or another amount of pulling force. The high output force from solenoid 214 allows solenoid 214 to engage and disengage latch 208 under stress and/or other strenuous conditions. For instance, solenoid 214 can be strong enough to disengage latch 208 when the animal is pushing against door 160 with significant force. Using a powerful solenoid 214 allows system 50 to utilize the full strength of crate 54 to secure the animal while still allowing users to reliably open door 160 remotely.

Receiver 218 is configured to receive wireless control signals from remote control 240 and/or other devices. Receiver 218 can communicate using radio frequency (RF) signals, Bluetooth, WiFi, and/or other forms of wireless communication. In one example, receiver 218 can communicate with an application on a smartphone. In another example, receiver 218 can communicate with multiple devices. For instance, receiver 218 can communicate with remote control 240, a smartphone, and/or another device. Receiver 218 can receive the same type of signal from multiple devices, such as similar RF and/or other types of signals transmitted by different devices. Alternatively, receiver 218 can receive different types of signals from different devices, such as multiple signals in different frequency bands and/or using different communication protocols. In one example, receiver 218 allows crate 54 to interface with an existing security system, home automation system, Internet of Things, and/or other external system. By allowing crate 54 to be controlled from multiple sources, receiver 218 can provide flexibility for users controlling crate 54. Further, communicating with multiple control sources can ensure crate 54 operates reliably, such as by using multiple redundant control signals.

In one example, receiver 218 can include multiple receiver devices. For example, receiver 218 can include a first receiver and a second receiver. The first receiver is configured to receive a control signal from a first device, such as remote control 240. The second receiver is configured to receive a control signal from a second device, such as a smartphone, tablet, personal computer, computer network, and/or another device. In one example, the second receiver can receive a control signal from an existing security system. With multiple receiver devices, system 50 can utilize a specialized remote control 240 adapted for crate 54 while also integrating with other devices and systems to control crate 54. In some cases, using multiple receiver devices can provide additional flexibility and reliability to users compared to using a single receiver device.

Additionally, in one example, receiver 218 can include an integrated controller that processes received control signals and then controls solenoid 214. Alternatively, crate 54 can include a separate controller that is communicatively connected to receiver 218 and solenoid 214. Further, receiver 218 can include one or more relays integrated into the housing of receiver 218. In response to a received control signal, receiver 218 can open or close the relays to energize or deenergize solenoid 214. As should be appreciated, crate 54 can include a variety of components that allow receiver 218 to control solenoid 214. In some cases, such components can be integrated into receiver 218 and/or solenoid 214, such as within the housing of such components.

Battery 220 is electrically connected to solenoid 214 and receiver 218. Battery 220 is configured to store and provide electrical power to solenoid 214, receiver 218, and/or additional components of crate 54. Battery 220 can be a lithium-ion, nickel-cadmium, nickel-metal hydride, and/or other type of battery. In one example, battery 220 can store up to 144 Watt-hours, 180 Watt-hours, 196 Watt-hours, 216 Watt-hours, 360 Watt-hours, and/or another amount of energy. Battery 220 can supply power at a variety of currents and voltages. As one particular example, battery 220 can store 8000 milliamp-hours supplied at 18 volts. Battery 220 helps crate 54 to be portable by providing an internal source of power for solenoid 214 and receiver 218. Alternatively or additionally, crate 54 can receive power from an external power source, such as by plugging into a wall outlet.

Typically, battery 220 is rechargeable. Crate 54 can include a charging port 222 that is electrically connected to battery 220 and that can connect battery 220 to an external power source to charge. Charging port 222 can be accessible outside of enclosed cavity 168. This allows battery 220 to remain attached to door 160 and be enclosed while being charged. Charging port 222 can be embedded in door 160 and/or cover 184. To indicate the charge level on battery 220, crate 54 can further include a battery gauge 224. Battery gauge 224 can display information about the state of battery 220, such as through numbers, words, and/or symbols. For instance, battery gauge 224 can include a group of LED segments that selectively illuminate to represent different charge percentages. Crate 54 can further include a button 226 that activates battery gauge 224. For example, battery gauge 224 can normally be off. Pressing button 226 can activate battery gauge 224 to display the charge state. Button 226 can toggle battery gauge 224 on and off or can temporarily activate battery gauge 224. Battery gauge 224 and button 226 are typically accessible outside of enclosed cavity 168. For example, battery gauge 224 and/or button 226 can be positioned on exterior side 166 of door 160 and/or cover 184.

Light 228 can include one or more LEDs, incandescent lights, and/or other types of lights. Light 228 is configured to illuminate interior space 86. In one example, light 228 can be controlled wirelessly, such as through remote control 240 and/or another device. For instance, receiver 218 can be communicatively connected to and configured to control light 228. In one example, light 228 can illuminate when door 160 is opened. In some examples, light 228 can illuminate and/or flash in multiple colors, such as to indicate that the animal has been released from crate 54.

Hinge 230 generally attaches door 160 to crate 54. Hinge 230 secures door 160 to body 70 while allowing door 160 to rotate relative to body 70. Door 160 can attach to body 70 through multiple hinges 230. Spring 232 can be attached to hinge 230 and/or integrated into hinge 230. Spring 232 is configured to bias hinge 230 toward an open position. When hinge 230 and spring 232 are attached to door 160 and body 70, spring 232 can bias door 160 outward from opening 88. Biasing door 160 in this way can allow door 160 to open automatically once solenoid 214 momentarily disengages latch 208. As should be appreciated, door 160 can be biased to open in variety of ways, such as through a gravity hinge and/or by tilting crate 54 as some examples.

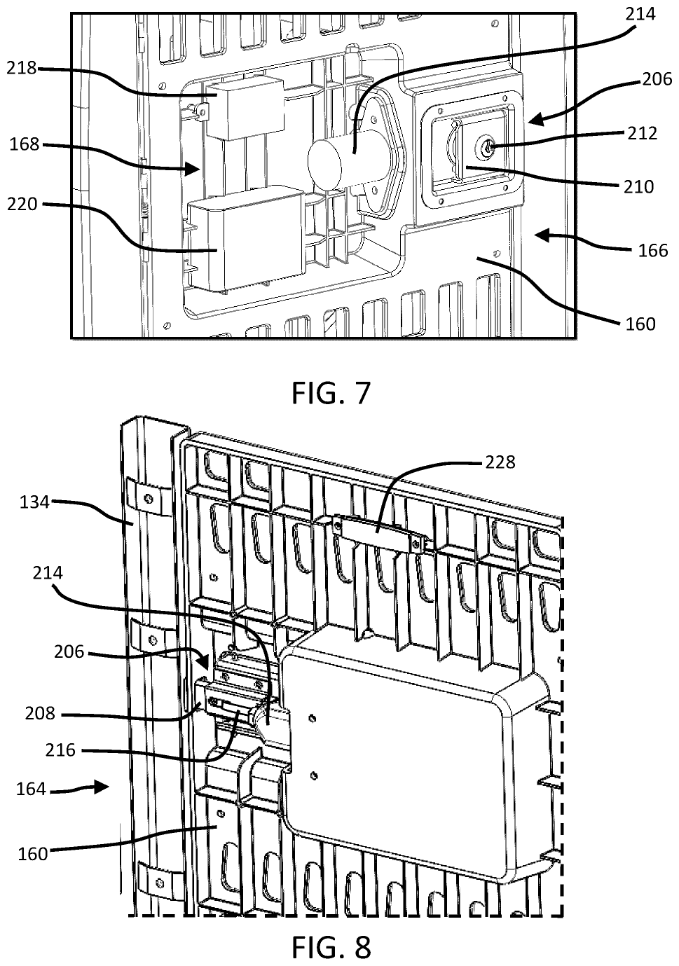

As shown in FIG. 7, solenoid 214, receiver 218, and battery 220 can be mounted to door 160 within enclosed cavity 168. As noted, enclosing components such as solenoid 214, receiver 218, and battery 220 can protect against environmental factors, such as dirt and moisture, and against potential damage caused by the animal. Wires and/or other electrical conductors connecting solenoid 214, receiver 218, and battery 220 can therefore be insulated from potentially damaging external conditions. Enclosed cavity 168 can open toward exterior side 166 when cover 184 is removed. Users can therefore access solenoid 214, receiver 218, and battery 220 while crate 54 is closed.

As shown in FIG. 8, solenoid 214 can couple to latch 208. When latch 208 is engaged and door 160 is closed, latch 208 secures door 160 in place relative to body 70. Solenoid 214 and/or latch 208 can be biased to keep latch 208 engaged. For example, when solenoid 214 is deenergized, solenoid 214 can be extended and hold latch 208 in the engaged position. Alternatively, latch 208 can be independently spring-loaded toward the engaged position. In the illustrated example, latch 208 can contact strut 134 when engaged. As noted, strut 134 can provide additional strength to body 70 around opening 88. Engaging latch 208 against strut 134 can additionally strengthen door 160 when closed. When latch 208 becomes disengaged, door 160 can rotate relative to body 70. Latch 208 can be disengaged by energizing solenoid 214. Energizing solenoid 214 can cause solenoid 214 to retract and move latch 208 to the disengaged state. As noted, latch 208 can also be disengaged through handle 210.

In the illustrated example, piston 216 of solenoid 214 can be directly coupled to latch 208. Many other electronic latches couple a solenoid to a latch through a lever and/or another form of mechanical advantage. Such arrangements can include low-force solenoids which utilize mechanical advantage to amplify the output force. Conversely, solenoid 214 can produce an output force that is larger than solenoids used in other electronic latches. Solenoid 214 can directly couple to latch 208 to transfer the same amount of force to latch 208 as produced by solenoid 214. In other words, solenoid 214 can transfer force to latch 208 without using any form of mechanical advantage. Using a strong solenoid 214 can allow latch 208 to move with a high degree of force, such as up to 80 Newtons, 100 Newtons, and/or another amount of force, while using direct coupling. Further, direct coupling between latch 208 and solenoid 214 can simplify the construction of crate 54 and can eliminate potential points of failure.

In the illustrated example, solenoid 214 can be only partially contained in enclosed cavity 168. For instance, part of solenoid 214, such as piston 216, can extend outside enclosed cavity 168 while the rest of solenoid 214 is positioned within enclosed cavity 168. The housing of solenoid 214 and/or a separate brace can seal against door 160 where piston 216 extends out of enclosed cavity 168. Arranging solenoid 214 in this way can ensure that the electrical components of solenoid 214 remain protected from moisture and/or dirt within enclosed cavity 168. In another version, solenoid 214 can be completely contained within enclosed cavity 168. In such an example, all or part of latch assembly 206 can be positioned within enclosed cavity 168.

As shown, light 228 can be mounted on interior side 164 of door 160. Positioning light 228 allows light 228 to illuminate interior space 86 of crate 54. Light 228 can allow a user to visually check on the animal in crate 54 when the environment is dark. In some examples, light 228 can illuminate when door 160 opens to indicate that door 160 is open and that the animal is released. Alternatively, light 228 can be positioned in one or more other locations to enhance visibility and/or indicate a state of crate 54.

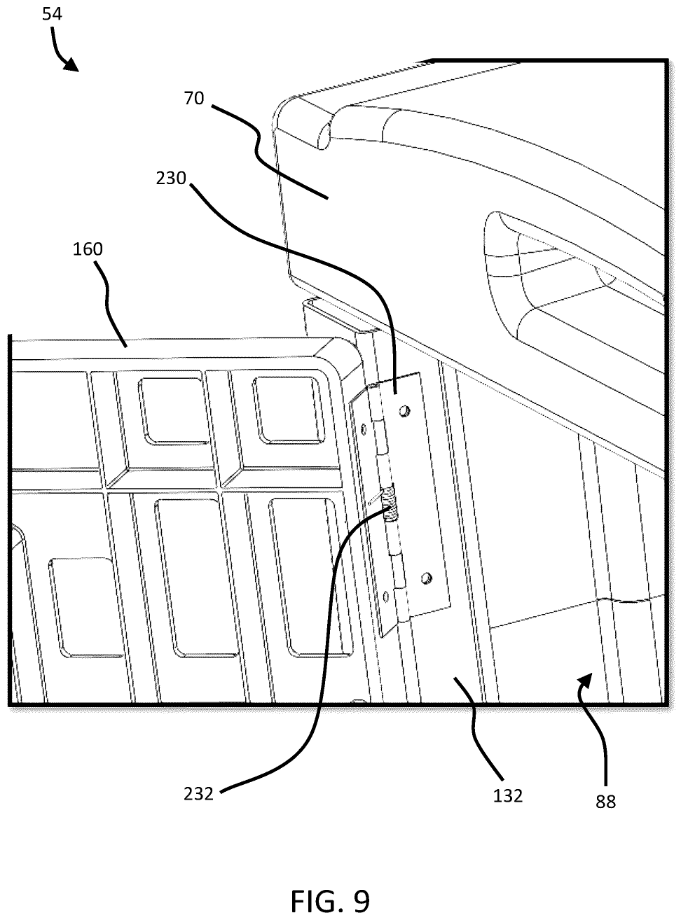

FIG. 9 illustrates hinge 230 coupling door 160 to body 70. In the illustrated example, hinge 230 can attach door 160 to strut 132. Attaching door 160 to strut 132 rather than directly to body 70 can reinforce door 160 at the pivot point. Hinge 230 can attach to door 160 and/or to strut 132 through fasteners, such as screws and/or bolts. As shown, spring 232 can bias door 160 towards an open position. When door 160 is closed and latch 208 becomes disengaged, spring 232 applies a force to swing door 160 to outwards from opening 88. Biasing door 160 in this way can help release the animal from crate 54 quickly once latch 208 is disengaged. Further, biasing door 160 with spring 232 can facilitate opening door 160 using only momentary energization of solenoid 214.

Various components of crate 54 can be arranged as a kit 60, as shown in FIG. 6. Kit 60 can be used to modify an existing door. Specifically, kit 60 can be installed on a door to allow users to remotely open and close the door. Kit 60 can be installed on a variety of types of doors, such as a door on a traditional kennel or crate, a gate in a fence, and/or other types of doors. In one example, kit 60 can include latch assembly 206, solenoid 214, receiver 218, and/or battery 220. In other examples, kit 60 can further include light 228, hinge 230, and/or spring 232. Kit 60 can further include cover 184. As a part of kit 60, cover 184 can be shaped in a variety of ways to accommodate different door shapes. In one example, cover 184 can be shaped to enclose solenoid 214, receiver 218, battery 220, and/or latch assembly 206 against a flat surface on a door. Kit 60 optionally includes remote control 240. As noted, receiver 218 can allow a user to control solenoid 214 using remote control 240 and/or another device, such as a smartphone or computer. As should be appreciated, kit 60 can include any combination of the components shown in FIG. 6 and/or additional components from system 50.

In one version, kit 60 can be arranged as an entire door assembly that retrofits onto another crate. Kit 60 can include remote control 240, door 160, cover 184, guard 200, latch assembly 206, solenoid 214, receiver 218, battery 220, light 228, hinge 230, and/or spring 232. By including such components, kit 60 can provide the full remote opening functionality from crate 54 to other crates and/or enclosures. Kit 60 can allow users to easily upgrade an existing crate by including all the necessary components. Further, by including all the components in the door assembly, kit 60 can ensure that all the components interact and function reliably. In one example, the components in kit 60 can further be pre-assembled for a user.

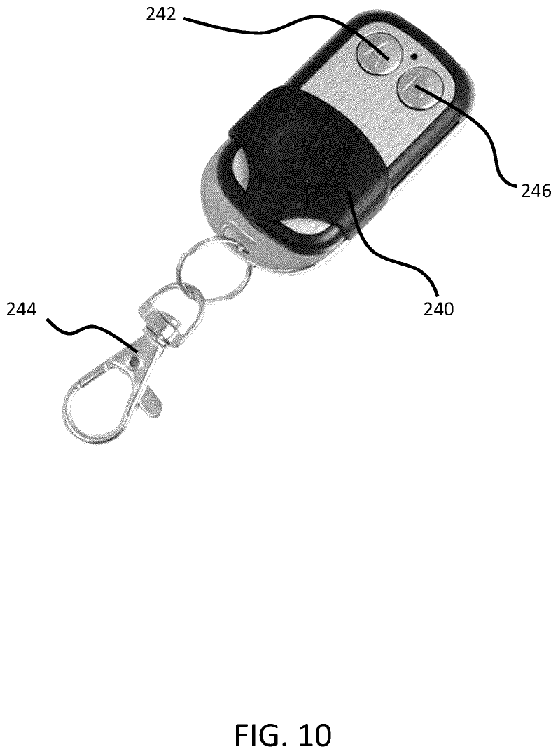

Referring to FIG. 10, remote control 240 generally includes a physical input 242. In the illustrated example, physical input 242 is a button. In other examples, physical input 242 can include a physical switch, a touchscreen, a voice control module, and/or another type of input device. When a user presses physical input 242, remote control 240 transmits a control signal to receiver 218 on crate 54. Typically, physical input 242 allows a user to control the state of latch 208. In one example, physical input 242 receives a momentary input, such as the push of a button. In another example, physical input 242 can be toggled, such as a switch being moved between two states. In some examples, the state of solenoid 214 can correspond with the state of physical input 242. For instance, solenoid 214 can momentarily energize when physical switch 242 is pressed momentarily, and/or solenoid 214 can switch between energized and deenergized states when a user toggles physical input 242.

As shown, remote control 240 can further include a clip 244. Clip 244 allows the user to attach remote control 240 to the user. This allows remote control 240 to be readily accessible to the user and can ensure the user does not lose remote control 240. Remote control 240 can further include an auxiliary input 246. Auxiliary input 246 can allow the user to control other parts of crate 54, such as light 228 and/or another component. For example, pressing auxiliary input 246 can turn light 228 on and/or off. In such an example, remote control 240 can be configured to communicate with receiver 218 over two channels, with control signals for solenoid 214 sent over one channel and control signals for light 228 sent over the other channel. As should be appreciated, physical input 242 and auxiliary input 246 can be arranged in a variety of ways to control parts of crate 54. In one example, remote control 240 can further include a safety. The safety can prevent remote control 240 from registering an input from a user and/or sending a control signal in response to a user input. The safety can ensure that the user does not accidentally open crate 54 by unintentionally pressing physical input 242. In this way, the safety can provide an additional layer of security and reliability for system 50.

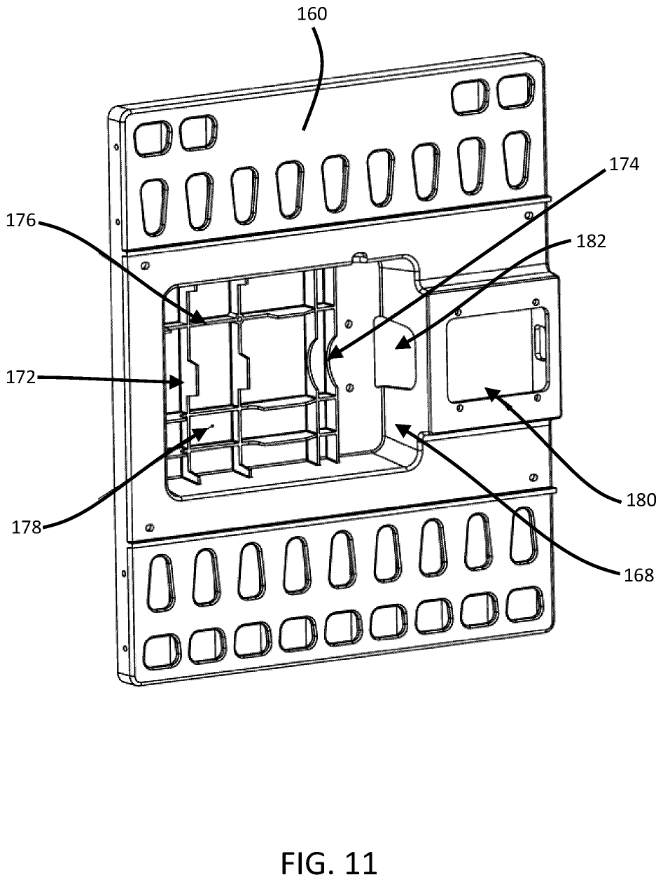

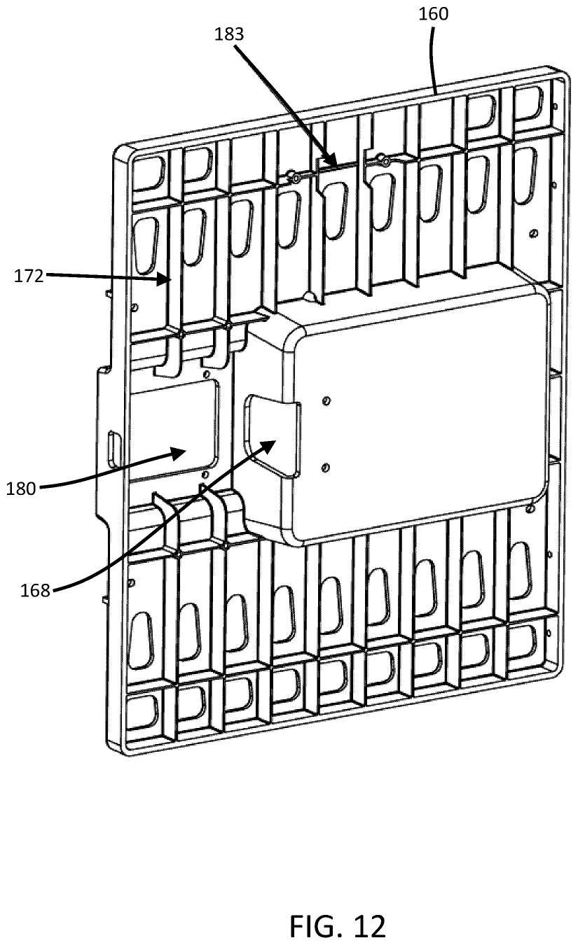

FIGS. 11, 12, and 13 illustrate a door assembly including door 160 and cover 184. In the illustrated example, door 160 can include ribs 172 positioned in enclosed cavity 168. Ribs 172 provide structural strength for door 160. As shown, ribs 172 can be arranged in a grid pattern. Further, ribs 172 can provide support for solenoid 214, receiver 218, battery 220, and/or other components. In the illustrated example, ribs 172 can define a solenoid recess 174, a receiver recess 176, and a battery recess 178. Solenoid recess 174, receiver recess 176, and battery recess 178 are generally shaped to receive and limit movement of solenoid 214, receiver 218, battery 220 respectively. For example, receiver recess 176 and battery recess 178 can limit movement of receiver 218 and battery 220 between top side 74 and bottom side 76 and between lateral sides 82 and 84. When cover 184 is attached to door 160, cover 184 and door 160 can cooperate to fix the positions of solenoid 214, receiver 218, and battery 220 between interior side 164 and exterior side 166 of door 160. In another example, door 160 can support and/or secure solenoid 214, receiver 218, and/or battery 220 in another way besides solenoid recess 174, receiver recess 176, and battery recess 178. For instance, solenoid 214, receiver 218, and/or battery 220 can attach to door 160 through fasteners. In yet another example, door 160 can include a different type of support instead of ribs 172.

Door 160 can further define a latch opening 180 and a solenoid opening 182. Latch opening 180 extends between interior side 164 and exterior side 166. Latch opening 180 generally provides a space for latch assembly 206 to mount to door 160. Latch opening 180 can be shaped to conform around part of latch assembly 206 and to limit movement of latch assembly 206. Solenoid opening 182 can extend from enclosed cavity 168 to interior side 164. Solenoid opening 182 can provide space for solenoid 214 to extend out of enclosed cavity 168 to contact latch assembly 206. In one example, solenoid 214 can seal against solenoid opening 182 to ensure that water is prevented from entering enclosed cavity 168. Further, door 160 can include additional ribs 172 on interior side 164 to provide structural support across door 160. On interior side 164, ribs 172 can define a light recess 183. Light recess 183 can be shaped to receive and limit movement of light 228. For example, light recess 183 can fix the position of light 228 relative to door 160 between top side 74 and bottom side 76 and between lateral sides 82 and 84. Light recess 183 can fix light 228 relative to door 160 in combination with fasteners and/or other fixing devices.

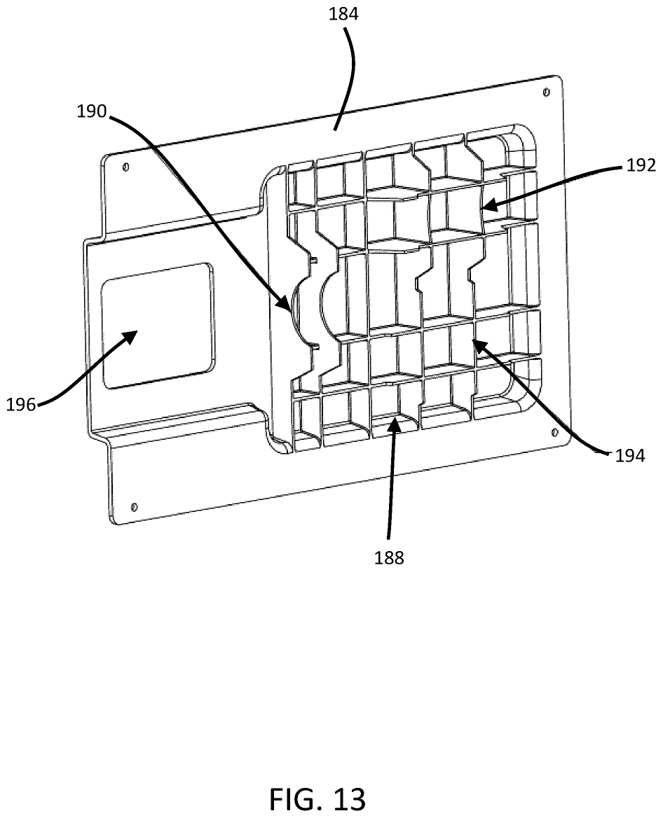

As shown in FIG. 13, cover 184 can include ribs 188 that provide structural strength. Ribs 188 can be arranged in a grid pattern. Further, similar to ribs 172 on door 160, ribs 188 can provide support for solenoid 214, receiver 218, battery 220, and/or other components positioned in enclosed cavity 168. In the illustrated example, ribs 188 can form a solenoid support 190, a receiver support 192, and a battery support 194. Solenoid support 190, receiver support 192, and battery support 194 are arranged in positions corresponding respectively with solenoid recess 174, receiver recess 176, and battery recess 178 on door 160 when cover 184 is attached. Solenoid support 190, receiver support 192, and battery support 194 are generally shaped to conform with portions of solenoid 214, receiver 218, and battery 220 respectively. Solenoid support 190 cooperates with solenoid recess 174 to fix solenoid 214 in place against door 160 within enclosed cavity 168. Similarly, receiver support 192 cooperates with receiver recess 176 to fix receiver 218 in place within enclosed cavity 168, and battery support 194 cooperates with battery recess 178 to fix battery 220 in place within enclosed cavity 168. Alternatively, door 160 can define solenoid support 190, receiver support 192, and/or battery support 194, and cover 184 can define solenoid recess 174, receiver recess 176, and/or battery recess 178. In yet another example, cover 184 can utilize another shape and/or structure besides ribs 188. As should be appreciated, cover 184 and door 160 can be shaped in a variety of ways to secure the positions of solenoid 214, receiver 218, battery 220, and/or other components in enclosed cavity 168.

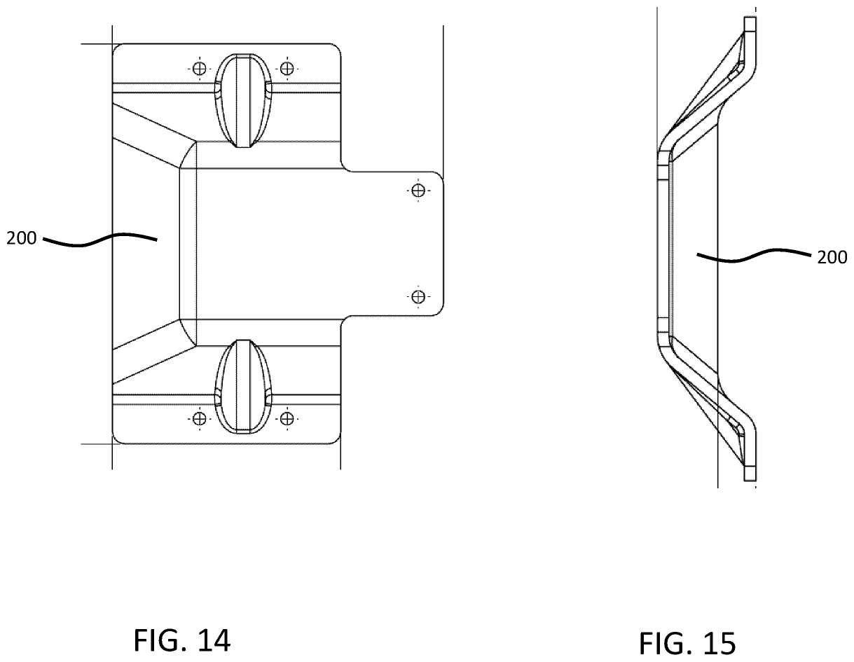

Referring to FIGS. 14 and 15, guard 200 can be made of a rigid material, such as a high-density plastic for example. As noted, guard 200 can be attached on interior side 164 of door 160. When attached on interior side 164 of door 160, guard 200 can extend around portions of latch assembly 206 and solenoid 214. For example, guard 200 can cover latch 208 and piston 216 when attached to door 160. Guard 200 can enclose and protect latch 208 and piston 216 from being tampered with and/or damaged by the animal held in crate 54. In some examples, guard 200 can seal against door 160 to protect latch assembly 206, solenoid 214, and/or other components from moisture, dirt, and/or other environmental factors. Guard 200 is generally configured to attach to door 160 using one or more fasteners, such as screws and/or bolts. Additionally or alternatively, guard 200 can attach to door 160 through a friction fit, snap-fit, and/or other type of connection.

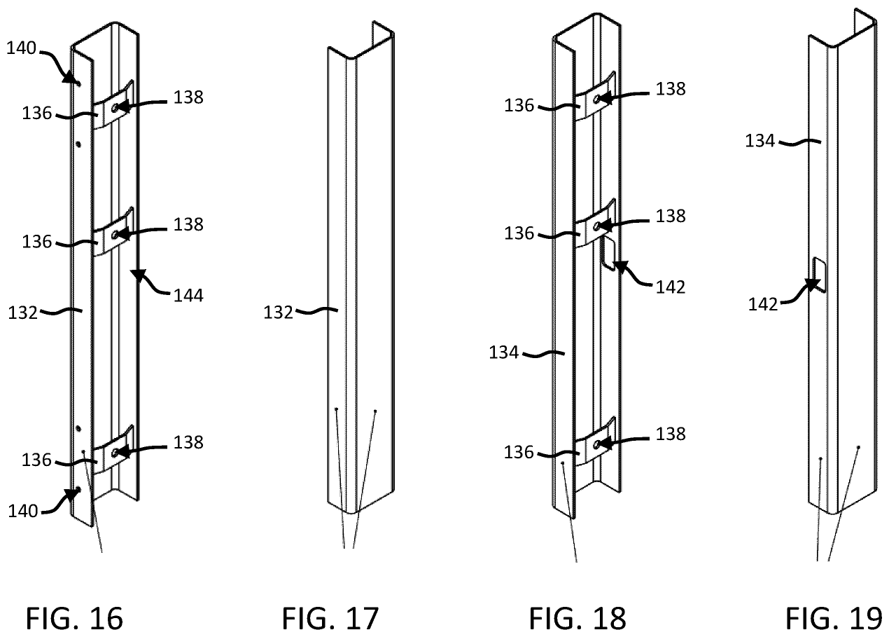

FIGS. 16-19 illustrate struts 132 and 134. Struts 132 and 134 each can include brackets 136. In the illustrated example, struts 132 and 134 can be formed by bending sheets of steel and/or another metal. Brackets 136 can bridge across portions within each strut 132 and 134. By bridging across sections of each strut 132 and 134, brackets 136 can reinforce each strut 132 and 134. In the illustrated example, each strut 132 and 134 can include three brackets 136 spaced apart between top side 74 and bottom side 76. Further, brackets 136 can provide a stable structure to anchor struts 132 and 134 to body 70. As shown, each bracket 136 can define a fastener opening 138. Fastener openings 138 can receive a fastener to secure struts 132 and 134 to body 70.

As noted, strut 132 can attach to body 70 on first lateral side 82 adjacent to opening 88. Strut 132 can attach to door 160 via hinge 230. Strut 132 can define additional fastener openings 140. Fastener openings 140 can receive fasteners to secure hinge 230 to strut 132. Securing door 160 to strut 132 can provide stronger coupling for door 160 compared to securing door 160 to body 70. Particularly, attaching door 160 to strut 132 can ensure that door 160 remains securely attached to crate 54 while pivoting about hinge 230. Strut 134 can attach to body 70 on second lateral side 84 adjacent to opening 88. Latch 208 can secure door 160 closed against strut 134. Strut 134 can define a hole 142 to receive latch 208. Compared to engaging latch 208 against body 70, engaging latch 208 against strut 134 can secure door 160 closed with greater strength and reliability.

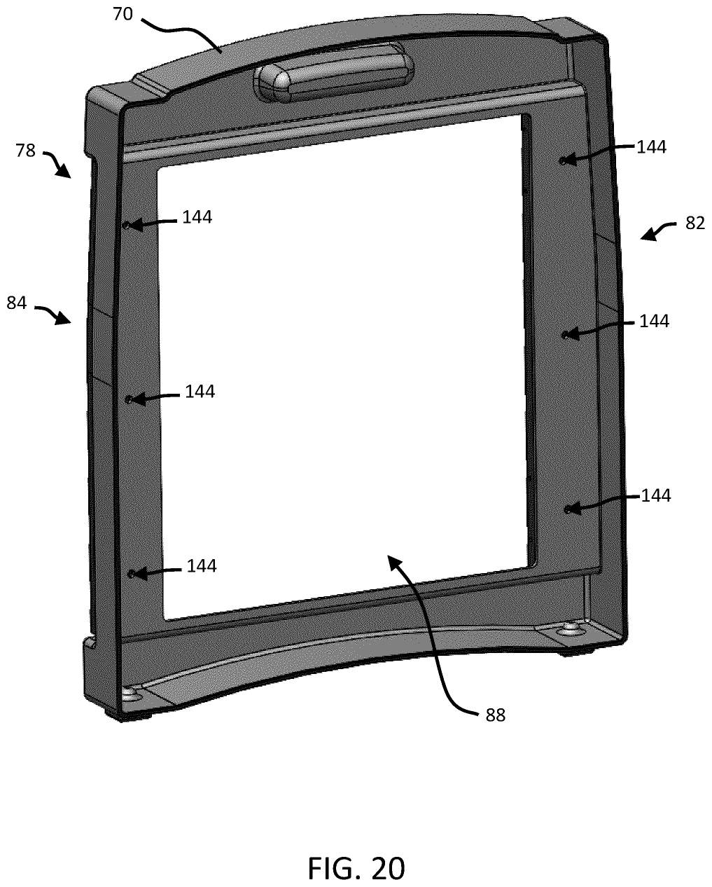

Referring to FIG. 20, body 70 can define fastener openings 144 on front side 78. Fastener openings 144 on body 70 can align with fastener openings 138 on struts 132 and 134. Struts 132 and 134 can attach to body 70 through fasteners positioned through openings 144 and 138. Fasteners can secure brackets 136 on each of struts 132 and 134 to body 70 to secure struts 132 and 134 in place. Additionally or alternatively, struts 132 and 134 can attach to body 70 through a friction fit, a snap-fit, and/or another type of connection.

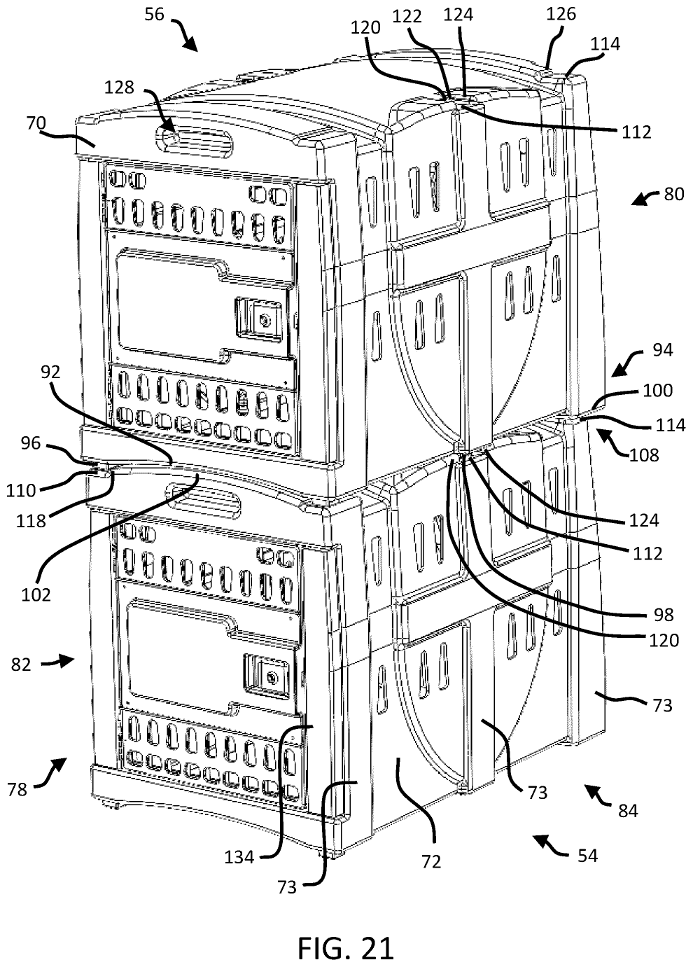

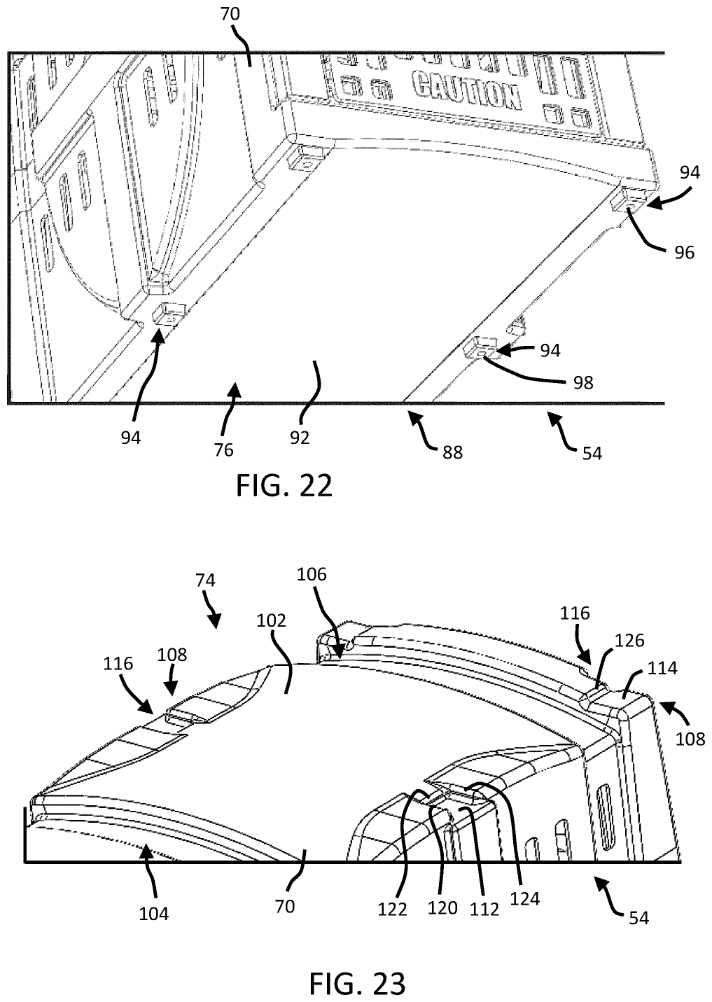

FIGS. 21-26 illustrate feet 94, platforms 108, and shoulders 116 used to stack multiple crates 54. As shown in FIG. 21, a second crate 56 can be stacked on crate 54. Crate 56 can generally include the same features as crate 54, including feet 94, platforms, 108, and shoulders 116. For instance, crate 56 can be identical to crate 54. Platforms 108 on crate 54 are configured to support feet 94 on crate 56. Shoulders 116 are configured to hold feet 94 on platforms 108 and to generally keep crate 56 centered on crate 54. In one example, shoulders 116 can completely fix the position of crate 56 relative to crate 54 in all horizontal directions. A user can stack any number of crates 54 in a stable arrangement using feet 94, platforms 108, and shoulders 116.

In the stacked arrangement, feet 94 of crate 54 support crate 54 above the ground. Feet 94 of crate 56 support crate 56 on roof 102 of crate 54. The shape of floor 92 of crate 56 can generally conform to the shape of roof 102 of crate 54. For example, floor 92 can be bowed to generally mirror the arched shape of roof 102. The conforming shapes of floor 92 and roof 102 can further secure crate 56 in place atop crate 54. When crate 56 stacks on crate 54, crate 56 is spaced above grooves 104 and 106. Crate 54 can still be tied down using grooves 104 and 106 when crate 56 is stacked on top. A user can tie down crates 54 and 56 using grooves 104 and 106 on either or both of crates 54 and 56.

As shown in FIGS. 21-23, crate 54 can include multiple feet 94 spaced along floor 92 and multiple platforms 108 spaced along roof 102. Crate 54 can include a front foot 96, a middle foot 98, and a rear foot 100. Front foot 96 is positioned toward front side 78, rear foot 100 is positioned toward back side 80, and middle foot 98 is positioned between front foot 96 and rear foot 100. In the illustrated example, front foot 96 and middle foot 98 can be shaped as distinct protrusions extending from floor 92 and rear foot 100 can be formed as a continuous shape with a portion of body 70. Front foot 96, middle foot 98, and rear foot 100 can be evenly spaced between front side 78 and back side 80. Similarly, crate 54 can include a front platform 110, a middle platform 112, and a rear platform 114. The positions of front platform 110, middle platform 112, and rear platform 114 generally mirror the positions of front foot 96, middle foot 98, and rear foot 100. Platforms 110 are shaped as flat surfaces to provide a stable area for each foot 94 to rest. In one example, the sizes and shapes of front platform 110, middle platform 112, and rear platform 114 can generally match the respective footprints of front foot 96, middle foot 98, and rear foot 100.

Crate 54 can include front foot 96, middle foot 98, and rear foot 100 on both lateral sides 82 and 84 along floor 92. Similarly, crate 54 can include front platform 110, middle platform 112, and rear platform 114 on both lateral sides 82 and 84 along roof 104. Positioning feet 94 and platforms 108 around a perimeter of crate 54 can evenly distribute the load of crate 54 and stacked crate 56. Alternatively, feet 94 and platforms 108 can be arranged in a different way. As noted, body 70 can include supports 73 positioned between each foot 94 and platform 98 to strengthen body 70 against vertical loads. Further, front platforms 110 can be positioned above struts 132 and 134. Struts 132 and 134 can act as support columns for front platforms 110 and any front feet 96 resting on front platforms 110.

Crate 54 defines front shoulders 118 adjacent to front platforms 110 and rear shoulders 126 adjacent to rear platforms 114. In the illustrated example, front shoulders 118 and rear shoulders 126 can be positioned medially towards the center of body 70 relative to front platforms 110 and rear platforms 114 respectively. The distances that front shoulders 118 and rear shoulders 126 extend above front platforms 110 and rear platforms 114 can approximate the heights of front feet 96 and rear feet 100. Shoulders 116 can bolster feet 94 by extending entirely or nearly entirely along the height of feet 94. Alternatively, front shoulders 118 and/or rear shoulders 126 can be arranged in other ways relative to front platforms 110 and/or rear platforms 114. In the illustrated arrangement, front shoulders 118 and rear shoulders 126 can cooperate to fix the position of crate 56 between lateral sides 82 and 84 when stacked on crate 54.

Crate 54 further defines multiple middle shoulders 120, 122, and 124 adjacent to middle platform 112. In the illustrated example, middle shoulder 120 can be positioned toward front side 78 and middle shoulder 124 can be positioned toward rear side 80 relative to middle platform 112. Middle shoulder 122 can be positioned medially toward the center of body 70 relative to middle platform 112. Alternatively, crate 54 can define a different number or arrangement of shoulders 116 near middle platforms 112. In the illustrated example, middle shoulders 120 and 124 can extend further above middle shoulder 122. Middle shoulders 120 and 124 can cooperate to fix the position of crate 56 between front side 78 and back side 80 when stacked on crate 54. Further, middle shoulders 122 on each lateral side 82 and 84 can help fix crate 56 between lateral sides 82 and 84 when stacked on crate 54.

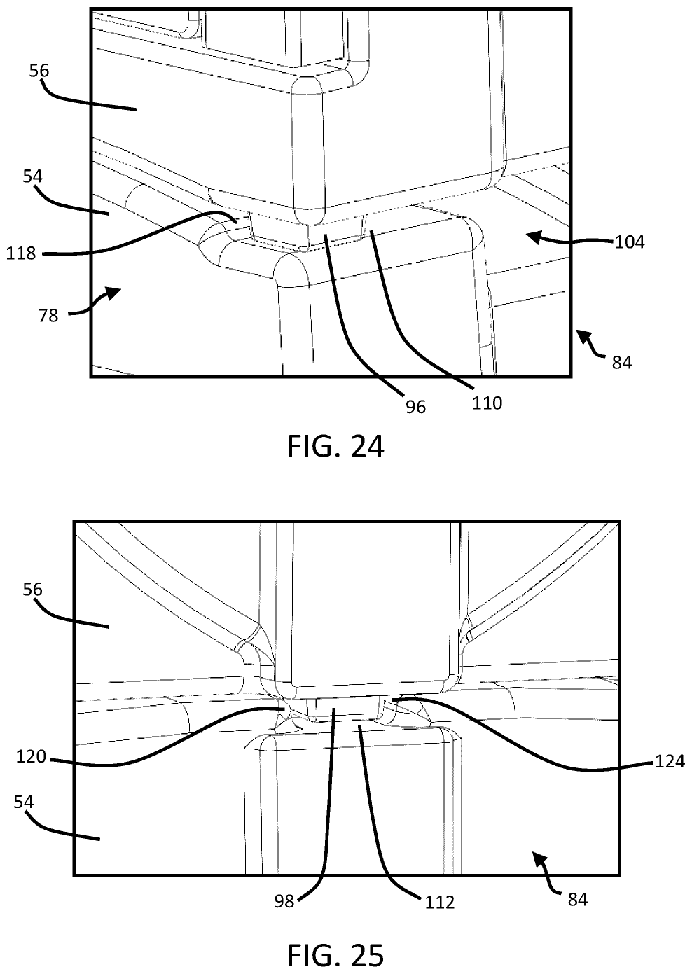

FIG. 24 shows front foot 96 of crate 56 positioned on front platform 110 of crate 54. Front foot 96 can abut front shoulder 118. Front shoulder 118 on second lateral side 84 can prevent front foot 96 from moving toward first lateral side 82. Front shoulders 118 and front feet 96 can be arranged symmetrically across lateral sides 82 and 84. Front shoulder 118 and front foot 96 on first lateral side 82 can be arranged in a mirrored orientation to the arrangement shown in FIG. 24. Front shoulder 118 on first lateral side 82 can prevent front foot 96 on first lateral side 82 from moving toward second lateral side 84. Therefore front shoulders 118 can collectively prevent movement of crate 56 relative to crate 54.

FIG. 25 shows middle foot 98 of crate 56 positioned on middle platform 112 of crate 54. As shown, middle shoulders 120 and 124 are positioned on opposite sides of middle foot 98. Middle foot 98 can abut middle shoulder 120 and/or middle shoulder 124. Middle shoulders 120 and 124 can sandwich middle foot 98. In this arrangement, middle shoulders 120 and 124 can fix the position of middle foot 98 between front side 78 and back side 80. Middle shoulders 120 and 124 can interact with middle feet 98 in the same way on both lateral sides 82 and 84. Further, middle shoulders 122 (not shown in FIG. 25) on both lateral sides 82 and 84 can cooperate to restrict middle feet 98 from moving between lateral sides 82 and 84.

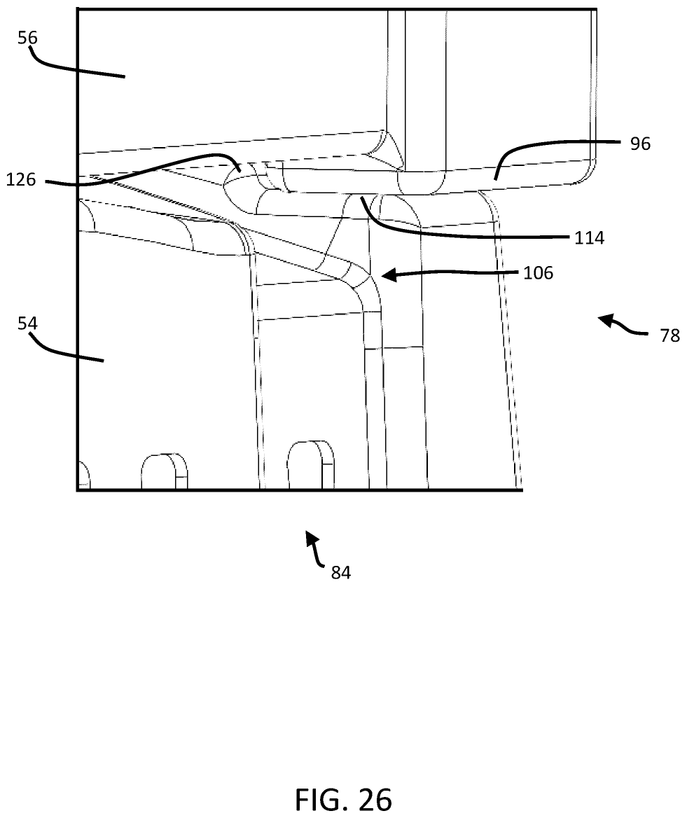

FIG. 26 shows rear foot 100 of crate 56 positioned on rear platform 114 of crate 54. Rear shoulders 126 can restrict rear feet 100 in a similar way to front shoulders 118 restricting front feet 96. Rear foot 100 can abut rear shoulder 126. Rear shoulder 126 on second lateral side 84 can prevent rear foot 100 from moving toward first lateral side 82. Rear shoulder 126 on first lateral side 82 can prevent rear foot 100 on first lateral side 82 from moving toward second lateral side 84. Therefore rear shoulders 126 can collectively prevent movement of crate 56 relative to crate 54.

The combination of front shoulders 118, rear shoulders 126, and middle shoulders 120, 122, and 124 can fully fix the position of crate 56 relative to crate 54 along roof 102. Shoulders 116 can restrict movement of crate 56 when stacked on crate 54 such that crate 56 can only move in an upward direction relative to crate 54. In one example, the weight of crate 56 and/or an animal inside crate 56 is sufficient to hold crate 56 down against crate 54. In another example, tie-downs positioned along grooves 104 and 106 can prevent crate 56 from moving upwards. Shoulders 118 and grooves 104 and 106 therefore can cooperate to allow a user to fully fix the position of multiple crates 54 stacked together, such as when transporting crates on a vehicle. As should be appreciated, shoulders 116 can be arranged in a variety of ways around platforms 108 to effectively secure crate 56 on top of crate 54.

While the present disclosure has been illustrated and described in detail in the drawings and foregoing description, the same is to be considered as illustrative and not restrictive in character, it being understood that a preferred embodiment has been shown and described and that all changes, equivalents, and modifications that come within the spirit of the claimed invention defined by following claims are desired to be protected. All publications, patents, and patent applications cited in this specification are herein incorporated by reference as if each individual publication, patent, or patent application were specifically and individually indicated to be incorporated by reference and set forth in its entirety herein.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Merriam-Webster dictionary.

1. A system comprising:
a crate for holding an animal, the crate comprising:
a body defining an interior space and an opening, wherein the interior space is large enough to contain a dog weighing at least 50 pounds, and wherein the opening is large enough to allow the dog to move through the opening;
a door rotatably coupled to the body, wherein the door is movable between an open position and a closed position, wherein the door covers the opening when in the closed position, wherein the door defines an enclosed cavity;
a latch attached to the door, wherein the latch is movable between an engaged state and a disengaged state, wherein the latch is adapted to secure the position of the door relative to the body when the latch is in the engaged state and the door is in the closed position, wherein the latch does not secure the position of the door relative to the body when the when the latch is in the disengaged state;
a handle positioned on an exterior side of the door relative to the interior space, wherein the handle is operatively coupled to the latch to move the latch from the engaged state to the disengaged state;
a solenoid operatively coupled to the latch to move the latch from the engaged state to the disengaged state, wherein the solenoid is adapted to move when transitioning between an energized state and a de-energized state; and a receiver adapted to receive a control signal, wherein the receiver is electrically connected to the solenoid;
wherein the solenoid transitions to the energized state when the receiver receives the control signal;
wherein the solenoid is adapted to move the latch into the disengaged state when the solenoid is in the energized state;
wherein the solenoid and the receiver are positioned within the enclosed cavity of the door.

2. The system of claim 1, wherein the crate further includes a cover, wherein the cover is removably attachable to the door, and wherein when the cover is attached to the door, the cover bounds a portion of the enclosed cavity and seals against the door to block water from entering the enclosed cavity.

3. The system of claim 1, wherein the crate further comprises a battery, wherein the battery is electrically connected to and adapted to provide power to the solenoid and the receiver, wherein the battery is contained within the enclosed cavity of the door.

4. The system of claim 3, wherein the crate further comprises a charging port, wherein the charging port is electrically connected to the battery, and wherein the charging port is accessible outside of the enclosed cavity.

5. The system of claim 1, wherein the crate further comprises a light, wherein the light is mounted on an interior side of the door, wherein the light is positioned outside of the enclosed cavity, and wherein the light is adapted to illuminate the interior space of the body.

6. The system of claim 1, wherein the latch is biased toward the engaged state, and wherein the solenoid is adapted to enter the energized state temporarily to momentarily disengage the latch when the receiver receives the control signal.

7. The system of claim 6, wherein the door is biased toward the open position.

8. The system of claim 1, wherein the solenoid is adapted to produce a force when transitioning from the de-energized state to the energized state, and wherein the solenoid is adapted to transfer energy to the latch using the same amount of force as the force produced by the solenoid.

9. The system of claim 1, wherein the solenoid is directly coupled to the latch.

10. The system of claim 1, wherein the latch further comprises a lock adapted to receive a key, and wherein, when the lock is placed in a locked state by the key, the lock secures the latch in the engaged position regardless of the state of the solenoid or handle.

11. The system of claim 1, wherein the receiver is adapted to communicate with an external security system.

12. The system of claim 1, further comprising a remote control, wherein the remote control is adapted to receive a physical input, and wherein the remote control is adapted to transmit the control signal to the receiver after receiving the physical input.

13. The system of claim 12, wherein the remote control includes a safety, and wherein the safety is adapted to selectively prevent the remote control from receiving the physical input.

14. The system of claim 1, wherein the body includes a floor on a bottom side, wherein the floor extends across the entire bottom side of the body, and wherein the floor is impermeable to water.

15. The system of claim 14, wherein the body includes plurality of feet extending from the floor on the bottom side, wherein the feet are adapted to support the body relative to a ground surface, and wherein the plurality of feet elevate the floor above the ground surface.

16. The system of claim 15, wherein the body includes a roof on a top side, wherein the roof defines a plurality of platforms, and wherein the plurality of platforms are positioned to mirror a location of each of the plurality of feet and are each adapted to support the feet on a second crate such that the crate is stackable with another identical crate.

17. The system of claim 16, wherein the body further comprises multiple shoulders positioned adjacent at least two of the plurality of platforms on the roof, wherein the shoulders extend above the platforms, and wherein when the feet of a second crate are positioned on the platforms, the shoulders block the second crate from moving towards a front, a back, and lateral sides of the body.

18. The system of claim 17, wherein the roof defines a groove adapted to receive a tie-down to secure the body against the ground surface.

19. The system of claim 1, wherein the body is made of a plastic material, wherein the crate further comprises a first and second strut, wherein the first and second strut are attached to the body, wherein a first strut is positioned along a first lateral side of the opening and is coupled to a hinge for the door, wherein a second strut is positioned on a second lateral side of the opening and is adapted to receive the latch, and wherein the struts provide structural support to the body around the opening.

20. A kit for use with an animal crate that defines an opening, the kit comprising:
a door that defines an enclosed cavity, wherein the door is adapted to be rotatably mounted on the animal crate to selectively cover the opening;
a cover that is removably attachable to the door, and wherein when the cover is attached to the door, the cover bounds a portion of the enclosed cavity and seals against the door to block water from entering the enclosed cavity;
a latch attached to the door, wherein the latch is movable between an engaged state and a disengaged state, wherein the latch is adapted to secure the position of the door relative to the animal crate when the latch is in the engaged state and the door is in a closed position, wherein the latch does not secure the position of the door relative to the body when the when the latch is in the disengaged state;
a handle positioned on an exterior side of the door relative to the interior space, wherein the handle is operatively coupled to the latch to move the latch from the engaged state to the disengaged state;
a solenoid operatively coupled to the latch to move the latch from the engaged state to the disengaged state, wherein the solenoid is adapted to move when transitioning between an energized state and a de-energized state; and a receiver adapted to receive a control signal, wherein the receiver is electrically connected to the solenoid;
a battery electrically connected to and adapted to provide power to the solenoid and the receiver, wherein the battery is contained within the enclosed cavity of the door;
a remote control adapted to receive a physical input, and wherein the remote control is adapted to transmit the control signal to the receiver after receiving the physical input;
wherein the solenoid transitions to the energized state when the receiver receives the control signal;
wherein the solenoid is adapted to move the latch into the disengaged state when the solenoid is in the energized state;
wherein the solenoid and the receiver are positioned within the enclosed cavity of the door.
